(19) United States
(12) Patent Application Publication
(10) Pub. No.: US 2021/0310413 A1
(43) Pub. Date: Oct. 7, 2021

(54) FUEL INJECTION DEVICE FOR GAS TURBINE

(71) Applicant: HONDA MOTOR CO., LTD., Tokyo (JP)

(72) Inventor: Orio NAKAMURA, Saitama (JP)

(21) Appl. No.: 17/166,551

(22) Filed: Feb. 3, 2021

(30) Foreign Application Priority Data
Feb. 28, 2020 (JP) 2020-033992

(51) Int. Cl. F02C 7/22; F23R 3/28

(52) U.S. Cl. CPC F02C 7/22; F05D 2240/36; F05D 2220/32; F23R 3/28

(57) ABSTRACT

A fuel injection device (70) includes a nozzle body (72) and a stem portion (110) connected to the rear end of the nozzle body at an angle. The stem portion is provided at a free end thereof with an annular wall member (128) defining a recess that receives the rear end of the nozzle body. The stem portion is covered by a heat insulating sleeve (122), and a part of the heat insulating sleeve adjacent to the free end of the stem portion is provided with a cutout (122B) exposing a part of the outer circumferential surface (128A) of the annular wall member. The exposed part of the annular wall member is provided with a heat insulating groove (130) opening at an end surface (128B) of the annular wall member facing the nozzle body.

### TECHNICAL FIELD

The present invention relates to a fuel injection device for a gas turbine.

### BACKGROUND ART

Since the fuel injection device (fuel injection nozzle) for a gas turbine is positioned in a high temperature region of the gas turbine, the temperature of the wall surface of the fuel passage formed in the fuel nozzle rises to such an extent that the coking of the fuel flowing through the fuel passage may occur.

To prevent the coking of the fuel in a fuel injection device including a nozzle body having a fuel injection port and a stem portion connected to the nozzle body to support the nozzle body relative to the casing, it has been proposed to surround the stem portion with a heat insulating sleeve. See JP2003-515718A, for example.

However, if the stem portion extends in an oblique direction with respect to the nozzle body, and a simple tubular heat insulating sleeve is employed, a part of the stem portion inevitably fails to be covered by the heat insulating sleeve. Therefore, the stem portion is not entirely heat insulated with the result that the coking of the fuel flowing through the fuel passage of the stem portion may still occur.

### SUMMARY OF THE INVENTION

In view of such a problem of the prior art, a primary object of the present invention is to provide a fuel injection device for a gas turbine that can prevent the occurrence of coking of the fuel flowing through the stem fuel passage even when the stem portion is not entirely covered by a heat insulating sleeve.

To achieve such an object, the present invention provides a fuel injection device (70) for a gas turbine, configured to inject fuel into a combustion chamber (52) defined by a combustor (54), comprising: a substantially cylindrical nozzle body (72) extending in a predetermined axial direction and having a first end (72A) facing the combustion chamber and a second end (72B) facing away from the first end; a substantially cylindrical stem portion (110) fixedly attached to a casing (14) surrounding the combustor at a base end (110A) thereof, extending from the base end in a direction inclined relative to the axial direction, and connected to the second end of the nozzle body at a free end thereof (110B); and a substantially cylindrical heat insulating sleeve (122) positioned on an outer periphery of the stem portion, wherein the nozzle body is provided with a nozzle fuel passage (86) extending in the axial direction and a fuel injection port (92) communicating with the nozzle fuel passage and positioned adjacent to the first end of the nozzle body, the stem portion is provided with a stem fuel passage (120) communicating with the nozzle fuel passage, and an annular wall member (128) at the free end thereof to define a recess (126) receiving the second end of the nozzle body, the annular wall member having an outer circumferential surface (128A) substantially coaxial with a central axial line (B) of the nozzle body, and a part of the heat insulating sleeve adjacent to the free end of the stem portion is provided with a cutout (122B) exposing a part of the outer circumferential surface of the annular wall member, and the exposed part of the annular wall member is provided with a heat insulating groove (130) opening at an end surface (128B) of the annular wall member facing the nozzle body.

Even though a part of the outer circumferential surface of the annular wall member is exposed due to the presence of the cutout in the heat insulating sleeve adjacent to the free end of the stem portion, owing to the heat insulating groove in the end surface of the annular wall member facing the nozzle body, the rise in the wall surface temperature of the stem fuel passage is reduced so that the occurrence of coking of the fuel flowing through the stem fuel passage is effectively prevented.

Preferably, the heat insulating groove extends in the end surface of the annular wall member facing the nozzle body in an arcuate shape substantially over an entire circumferential extent of the exposed part of the annular wall member.

Since the heat insulating groove extends over an entire circumferential extent of the exposed part of the annular wall member in an arcuate shape, heat insulation of the exposed part of the annular wall member is effectively performed.

Preferably, a heat shield plate (85) facing the end surface of the annular wall member with a prescribed gap (87) is provided on the nozzle body.

Thereby, heat transfer to the annular wall member is reduced so that the rise of the wall surface temperature of the stem fuel passage is decreased.

Preferably, the heat shield plate includes a flange (85) extending radially outward from the nozzle body.

Thereby, the heat shield plate can be formed without adding any new component parts.

The present invention thus provides a fuel injection device for a gas turbine that can prevent the occurrence of coking of the fuel flowing through the stem fuel passage even when the stem portion is not entirely covered by a heat insulating sleeve.

### BRIEF DESCRIPTION OF THE DRAWING(S)

FIG. 1 is a longitudinal sectional view of an aircraft gas turbine engine fitted with fuel injection devices according to an embodiment of the present invention;

FIG. 2 is a side view of the fuel injection device including a nozzle body and a stem portion;

FIG. 3 is a sectional view of the fuel injection device;

FIG. 4 is a sectional view of the fuel injection device taken along line IV-IV of FIG. 3; and

FIG. 5 is a view of the stem portion as viewed from the direction indicated by arrows V-V of FIG. 3.

### DESCRIPTION OF THE PREFERRED EMBODIMENT(S)

A fuel injection device according to an embodiment of the present invention as applied to an aircraft gas turbine engine is described in the following with reference to the appended drawings.

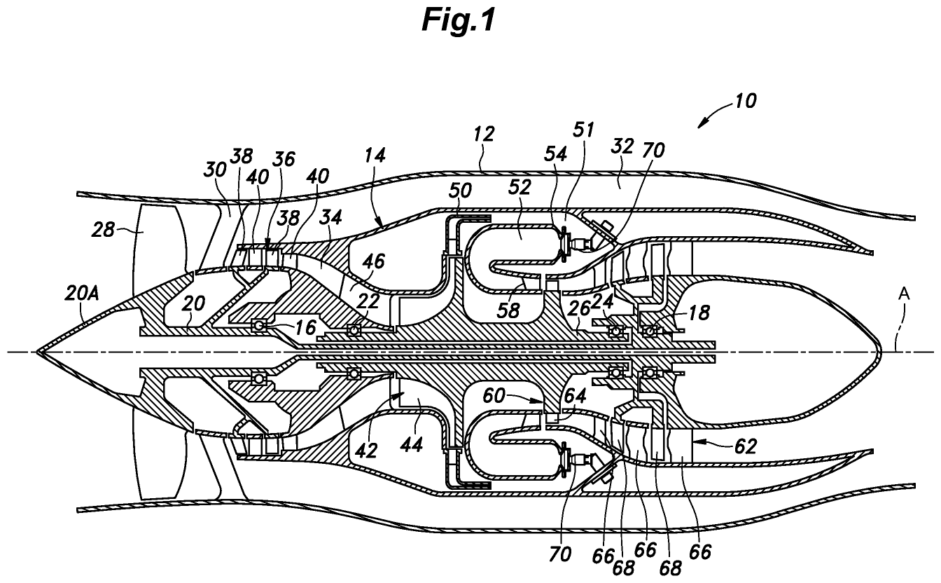

First of all, an overall structure of the aircraft gas turbine engine (turbofan engine) is briefly described in the following with reference to FIG. 1.

The gas turbine 10 has a substantially cylindrical outer casing 12 and an inner casing 14 arranged in a coaxial relationship. The inner casing 14 rotatably supports a low-pressure rotary shaft 20 via a front first bearing 16 and a rear first bearing 18. The low-pressure rotary shaft 20 is surrounded by a hollow high-pressure rotary shaft 26 in a coaxial relationship, and the high-pressure rotary shaft 26 is rotatably supported by the inner casing 14 via a front second bearing 22 and a rear second bearing 24.

Thus, the low-pressure rotary shaft 20 and the high-pressure rotary shaft 26 are arranged coaxially to a central axial line A of the gas turbine 10.

The front end of the low-pressure rotary shaft 20 is flitted with a substantially conical tip portion 20A protruding forward from the inner casing 14. A plurality of front fan blades 28 are provided in a single row on the outer periphery of the tip portion 20A, and a plurality of stator vanes 30 extend radially inward from the outer casing 12 in a single row to be positioned immediately downstream of the front fan blades 28. On the downstream side of the stator vanes 30 are located a bypass duct 32 having an annular cross section defined between the outer casing 12 and the inner casing 14 and an air compression duct 34 (annular fluid passage) having an annular cross section defined within the inner casing 14 in a mutually coaxial and parallel relationship.

An axial flow compressor 36 is provided at the inlet of the air compression duct 34. The axial flow compressor 36 includes a pair of rows of rotor blades 38 extending radially outward from the outer periphery of the low-pressure rotary shaft 20, and a pair of rows of stationary vanes 40 provided on the inner casing 14 so as to alternate with the rows of rotor blades 38 along the axial direction.

A centrifugal compressor 42 is provided at the outlet of the air compression duct 34. The centrifugal compressor 42 includes an impeller 44 fixedly fitted on the high-pressure rotary shaft 26. A strut 46 is positioned immediately upstream of the impeller 44. A diffuser 50 is fixed to the inner casing 14 at the outlet end of the centrifugal compressor 42.

A combustor 54 with an annular configuration is provided downstream of the diffuser 50. The combustor 54 internally defines an annular backflow combustion chamber 52 centered around the central axial line A. The compressed air exiting from the diffuser 50 is supplied to the backflow combustion chamber 52 via a compressed air passage 51.

A plurality of fuel injection devices 70 for injecting fuel into the backflow combustion chamber 52 are provided in the rear end parts of the combustor 54 at regular intervals along the circumferential direction. Each fuel injection device 70 includes a nozzle body 72 extending in parallel with the central axial line A of the gas turbine 10 and connected to the combustor 54 at the front end thereof, and a stem portion 110 extending from a side part of the nozzle body 72 through the inner casing 14, and fixedly attached to the inner casing 14 as will be described hereinafter. Each fuel injection device 70 is configured to inject fuel into the backflow combustion chamber 52. The injected fuel is mixed with the compressed air introduced from the compressed air passage 51, and the mixture is combusted in the backflow combustion chamber 52. As a result, high-temperature combustion gas is generated in the backflow combustion chamber 52.

The combustion gas generated in the backflow combustion chamber 52 is forwarded to a high-pressure turbine 60 and a low-pressure turbine 62 provided on the downstream of the backflow combustion chamber 52. The high-pressure turbine 60 includes a row of stationary vanes 58 fixed to the outlet end of the backflow combustion chamber 52, and a row of moveable blades 64 fixed to the outer periphery of the high-pressure rotary shaft 26. The low-pressure turbine 62 is located on the downstream side of the high-pressure turbine 60, and includes a plurality of rows of stationary vanes 66 fixed to the inner casing 14 and a plurality of rows of moveable blades 68 fixed the outer periphery of the low-pressure rotary shaft 20 so as to alternate with the rows of stationary vane 66 along the axial direction.

When starting the gas turbine 10, the high-pressure rotary shaft 26 is rotationally driven by a starter motor (not shown in the drawings). When the high-pressure rotary shaft 26 is rotationally driven, the air compressed by the centrifugal compressor 42 is supplied to the backflow combustion chamber 52, and combustion gas is generated in the backflow combustion chamber 52 by the combustion of the air-fuel mixture. The combustion gas is impinged upon the moveable blades 64 and 68 to rotate the high-pressure rotary shaft 26 and the low-pressure rotary shaft 20, respectively.

As a result, the low-pressure rotary shaft 20 and the high-pressure rotary shaft 26 are rotationally driven so that the front fan blades 28 are rotated, and the axial flow compressor 36 and the centrifugal compressor 42 are operated. The resulting compressed air is supplied to the backflow combustion chamber 52 causing the gas turbine 10 to be continuously operated without the aid of the starter motor.

During the operation of the gas turbine 10, a part of the air drawn by the front fan blades 28 passes through the bypass duct 32 defined between the outer casing 12 and the inner casing 14, and is ejected from the rear end of the gas turbine 10 to generate thrust. The rest of the air drawn by the front fan blades 28 is supplied to the backflow combustion chamber 52 to be mixed with fuel, and the combustion gas generated in the backflow combustion chamber 52 contributes to the rotational drive of the low-pressure rotary shaft 20 and the high-pressure rotary shaft 26, and then ejected rearward to generate additional thrust.

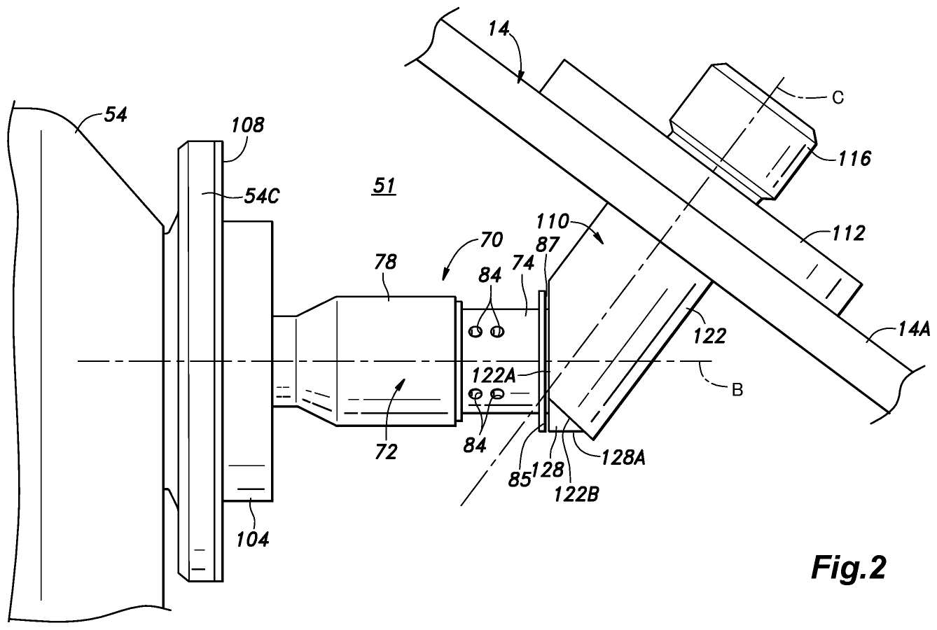

The details of the fuel injection device 70 are described in the following with reference to FIGS. 2 to 5. The fuel injection device 70 includes the cylindrical nozzle body 72 and the stem portion 110 as discussed earlier.

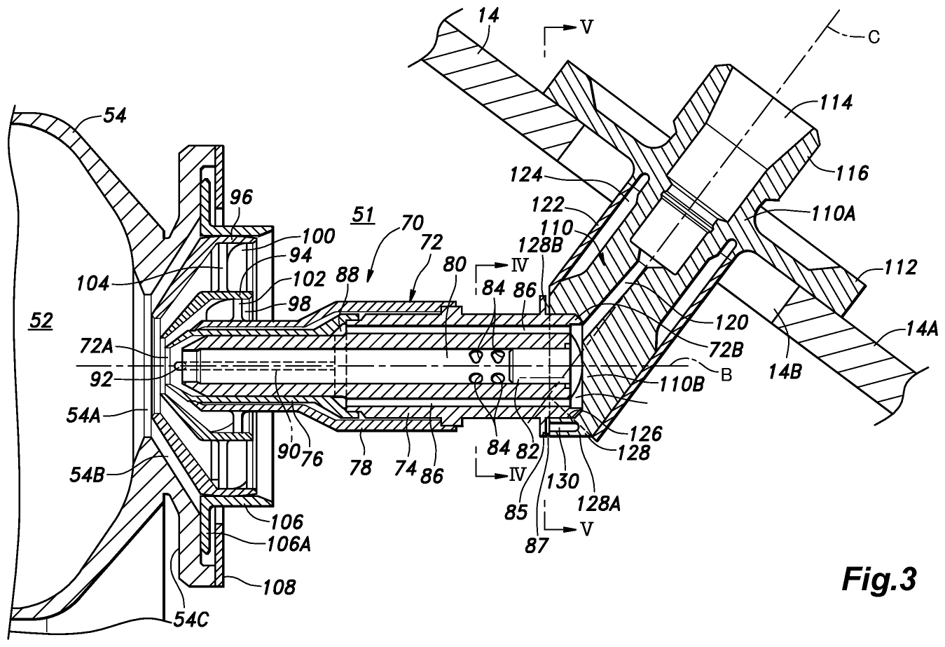

As shown in FIGS. 2 and 3, the central axial line B of the nozzle body 72 extends in parallel with the central axial line A of the gas turbine 10, and the nozzle body 72 includes a cylindrical central cylinder 74, an intermediate cylinder 76, and an outer cylinder 78, all arranged in a coaxial relationship to the central axial line B of the nozzle body 72. The nozzle body 72 has a first end 72A facing the backflow combustion chamber 52, and a second end 72B facing away from the first end 72A with respect to the axial direction.

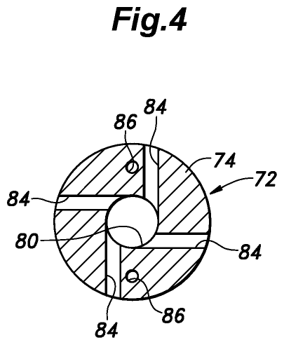

The central cylinder 74 defines a central air passage 80 extending along the central axial line B, and the central air passage 80 is closed by a plug 82 at the second end 72B of the central cylinder 74. As shown in FIG. 4, a plurality of air introduction holes 84 are passed through the wall of the central cylinder 74 each extending in a tangential direction to the central air passage 80.

High-pressure air drawn from the centrifugal compressor 42 is introduced into the central air passage 80 via the air introduction holes 84. As a result, a swirl flow centered around the central axial line B is created in the central air passage 80 owing to the tangentially directed air introduction holes 84. The high-pressure air containing the swirl flow is expelled from the open end of the central air passage 80 on the side of the first end 72A or toward the backflow combustion chamber 52.

The central cylinder 74 is provided with a first nozzle fuel passage 86 consisting of a pair of axially extending holes arranged at diametrically opposing positions. The front end of the first nozzle fuel passage 86 (on the side of the first end 72A) communicates with an annular second nozzle fuel passage 88 defined by a flared rear end of the intermediate cylinder 76 between the central cylinder 74. A pair of axial grooves are formed in the outer circumferential surface of the central cylinder 74 at diametrically opposing positions which are circumferentially offset from the first nozzle fuel passage 86 by 90 degrees. The front part of the central cylinder 74 beyond the annular second nozzle fuel passage 88 is closely fitted into the intermediate cylinder 76 so that a third nozzle fuel passage 90 is defined by the axial grooves in the central cylinder 74 in cooperation with the inner circumferential surface of the intermediate cylinder 76. The front ends of the axial grooves on the side of the first end 72A form fuel injection ports 92. Optionally, the fuel injection ports 92 may be provided with a fuel swirler. The inner circumferential surface of the outer cylinder 78 is slightly spaced from the outer circumferential surfaces of the intermediate cylinder 76 and the central cylinder 74 so that an annular space is created between the outer cylinder 78 and the intermediate cylinder 76 and the central cylinder 74. This annular space functions as a heat insulator for the nozzle fuel passage 86, 88 and 80.

An enlarged inner cylinder 94 and an enlarged outer cylinder 96 having a larger inner diameter than the outer diameter of the enlarged inner cylinder 94 are fitted on the front end (on the side of the first end 72A) of the outer cylinder 78 in a coaxial relationship to the central axial line B of the fuel injection device 70. An annular outer air passage 98 is defined between the intermediate cylinder 76 and the enlarged inner cylinder 94, and another annular outer air passage 100 is defined between the enlarged inner cylinder 94 and the enlarged outer cylinder 96.

The outer air passages 98 and 100 are provided with swirl flow generating vanes 100 and 102 that create swirl flows around the central axial line B. As a result, the high-pressure air expelled from the outer air passages 98 and 100 toward the backflow combustion chamber 52 becomes a swirl flow around the central axial line B.

The cylindrical central cylinder 74, the intermediate cylinder 76, the outer cylinder 78, the enlarged inner cylinder 94, and the enlarged outer cylinder 96 taper toward the first end 72A so as to define tapered nozzle ends.

The combustor 54 is provided with a plurality of circular openings 54A arranged circumferentially at regular intervals around the central axial line A of the gas turbine 10, and each circular opening 54A is centered on the central axial line B. The open end 54B or the rear end of the circular opening 54A is flared so as to conform to the tapered profile of the enlarged outer cylinder 96. The circular opening 54A is surrounded by a radial flange 54C which is integral with the wall of the combustor 54. The nozzle body 72 is attached to the combustor 54 via a flanged collar 106. The collar 106 is attached to the outer surface of the enlarged outer cylinder 96 in a coaxial relationship. A flange 106A of the collar 106 is interposed between the rear end surface of the radial flange 54C and a mounting plate 108 having a coaxial annular shape and fixedly attached to the rear face of an outer peripheral part of the radial flange 54C so as to create a certain play in both the radial direction and the axial direction so that the nozzle body 72 is slightly moveable relative to the combustor 54 both in the radial direction and the axial direction.

Thus, the nozzle body 72 supplies air-fuel mixture consisting of the fuel injected from the fuel injection ports 92 and the compressed air conducted through the central air passage 80 and the outer air passages 98 and 100 into the backflow combustion chamber 52 via the circular opening 54A. A major part of this air-fuel mixture consists of a swirl flow centered around the central axial line B of the nozzle body 72. Since the air-fuel mixture supplied into the backflow combustion chamber 52 is a swirl flow around the central axial line B, the fuel contained in the mixture is turned into fine particles, and is favorably vaporized.

The stem portion 110 is passed through the opening 14B formed in an inclined wall part 14A of the inner casing 14, and is provided with a radial flange 112 abutting against the outer surface of the inclined wall part 14A in a base end part 110A thereof. The stem portion 110 is fixedly attached to the inclined wall part 14A by securing the radial flange 112 thereto with threaded bolts not shown in the drawings. The stem portion 110 is further provided with a free end part 110B which extends toward the central axial line B of the nozzle body 72 at an angle thereto, and connected to the second end 72B of the nozzle body 72. The stem portion 110 is provided with a linear, cylindrical shape having a central axial line C.

The stem portion 110 is internally provided with a stem fuel passage 120 that communicates with the nozzle fuel passage 86 and opens at the rear end (base end) of the stem portion 110 to form a fuel inlet 116.

The stem portion 110 is provided with an annular wall member 128 at the free end 110B thereof to define a circular recess 126 that receives the second end 72B of the central cylinder 74 of the nozzle body 72 in a tight fit. The stem portion 110 having a circular cross section and the central cylinder 74 also having a circular cross section are joined to each other from an oblique direction, and the free end 110B of the stem portion 110 is shaped in such a manner that the annular wall member 128 has an outer circumferential surface 128A substantially coaxial with the central axial line (nozzle axis) B of the nozzle body 72.

The central cylinder 74 of the nozzle body 72 is provided with a radial flange 85 on the side of the second end 72B thereof, and this radial flange 85 opposes the end surface 128B of the annular wall member 128 via a small gap 87.

A substantially cylindrical heat insulating sleeve 122 is fitted over the outer circumference surface of the stem portion 110. A longitudinally middle part of the stem portion 110 is reduced in diameter. As a result, an annular heat insulating space 124 is defined between the reduced-diameter portion of the stem portion 110 and the heat insulating sleeve 122.

Since the junction between the stem portion 110 and the nozzle body 72 is irregular in shape while the heat insulating sleeve 122 has a substantially cylindrical shape having a constant cross section, it is not possible to cover the entire stem portion 110 with the heat insulating sleeve 122. Therefore, as shown in FIGS. 2, 3 and 5, the end surface of the heat insulating sleeve 122 on the side of the free end 110B of the stem portion 110 includes a first end surface 122A which is orthogonal to the central axial line B of the nozzle body 72 and a second end surface 122B which is substantially orthogonal to the central axial line C of the stem portion 110. In particular, the first end surface 122A forms an upper part of the end surface of the heat insulating sleeve 122 while the second end surface 122B forms a lower part of the same. The first end surface 122A abuts against or closely opposes the radial flange 85 over an angular range somewhat greater than 180 degrees around the central axial line B of the nozzle body 72. The second end surface 122B extends obliquely downward in a direction away from the radial flange 85 in side view. As a result, a crescent shaped area of the outer circumferential surface 128A of the annular wall member 128 devoid of the heat insulating sleeve 122 is created; namely, a part of the heat insulating sleeve 122 adjacent to the free end 110B is provided with a cutout exposing a part (crescent shaped area) of the outer circumferential surface 128A of the annular wall member 128.

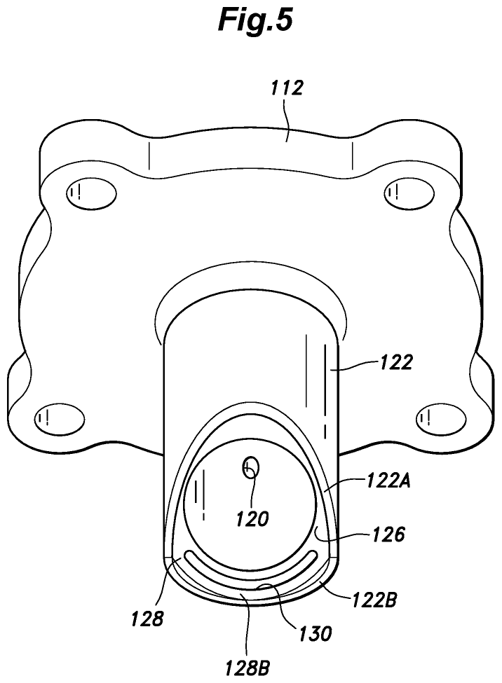

The exposed part of the outer circumferential surface 128A of the annular wall member 128 is formed with a heat insulating groove 130 opening at the end surface 128B of the annular wall member 128 facing the nozzle body 72. As shown in FIG. 5, the heat insulating groove 130 preferably extends in an arcuate shape along a circle centered around the central axial line B of the nozzle body 72 so as to substantially correspond to the expanse of the exposed part (crescent shaped area) of the outer circumferential surface 128A of the annular wall member 128. In other words, the heat insulating groove 130 extends in an arcuate shape over the entire circumferential extent of the exposed part of the annular wall member 128.

The flange 85 of the nozzle body 72 serves as a heat shield plate facing the end surface 128B of the annular wall member 128 with a relatively small gap 87.

Thus, a large part of the stem portion 110 is insulated from the outside by the heat insulating sleeve 122 and the heat insulating space 124 so that the temperature rise of the fuel flowing through the stem fuel passage 120 is minimized. Further, the portion of the annular wall member 128 exposed by the second end surface 122B (or cutout) of the heat insulating sleeve 122 is insulated (heat shielded) from the outside by the heat insulating groove 130 so that the temperature rise of the fuel flowing through the stem fuel passage 120 is minimized.

Since the flange 85 opposes the opposing end surface of the stem portion 110 with the gap 87 functioning as a heat insulating layer, and acts as a heat shield plate that blocks heat transfer from the side of the combustor 54 to the end surface 128B of the annular wall member 128, the temperature rise of the annular wall member 128 can be minimized, and the temperature rise of the fuel flowing from the stem fuel passage 120 to the nozzle fuel passage 86 is minimized.

As a result, the rise in the wall surface temperature of the stem fuel passage 120 is reduced, and the coking of the fuel flowing from the stem fuel passage 120 and the stem fuel passage 120 to the nozzle fuel passage 86 can be effectively avoided. Thus, the coking resistance of the fuel injection device 70 can be improved.

Since the heat shielding action is performed by the flange 85 of the nozzle body 72, no special heat shielding plate member is required for the heat shielding action.

The present invention has been described in terms of a specific embodiment, but is not limited by such an embodiment, and can be modified in various ways without departing from the scope of the present invention. For example, the heat insulating groove 130 is not necessarily required to extend in an arcuate shape over the entire extent of the exposed portion of the annular wall member 128, but may extend only a part of the circumferential extent of the exposed portion of the annular wall member 128 depending on the required heat insulating property. Conversely, the heat insulating groove 130 may extend over a large circumferential extent, and even the entire circumference of the annular wall member 128 depending on the required heat insulating property.

The fuel injection device according to the present invention is not limited to the fuel nozzle of the airflow atomization type, but is also applicable to the fuel injection devices of the pressure spray type and the air assist type. Further, the application of the fuel injection device according to the present invention is not limited to aircraft gas turbines abut also to gas turbines for driving generators and other devices.

1. A fuel injection device for a gas turbine, configured to inject fuel into a combustion chamber defined by a combustor, comprising:
a substantially cylindrical nozzle body extending in a predetermined axial direction and having a first end facing the combustion chamber and a second end facing away from the first end;
a substantially cylindrical stem portion fixedly attached to a casing surrounding the combustor at a base end thereof, extending from the base end in a direction inclined relative to the axial direction, and connected to the second end of the nozzle body at a free end thereof; and
a substantially cylindrical heat insulating sleeve positioned on an outer periphery of the stem portion,
wherein the nozzle body is provided with a nozzle fuel passage extending in the axial direction and a fuel injection port communicating with the nozzle fuel passage and positioned adjacent to the first end of the nozzle body,
the stem portion is provided with a stem fuel passage communicating with the nozzle fuel passage, and an annular wall member at the free end thereof to define a recess receiving the second end of the nozzle body, the annular wall member having an outer circumferential surface substantially coaxial with a central axial line of the nozzle body, and
a part of the heat insulating sleeve adjacent to the free end of the stem portion is provided with a cutout exposing a part of the outer circumferential surface of the annular wall member, and the exposed part of the annular wall member is provided with a heat insulating groove opening at an end surface of the annular wall member facing the nozzle body.

2. The fuel injection device according to claim 1, wherein the heat insulating groove extends in the end surface of the annular wall member facing the nozzle body in an arcuate shape substantially over an entire circumferential extent of the exposed part of the annular wall member.

3. The fuel injection device according to claim 1, wherein a heat shield plate facing the end surface of the annular wall member with a prescribed gap is provided on the nozzle body.

4. The fuel injection device according to claim 3, wherein the heat shield plate includes a flange extending radially outward from the nozzle body.
